(19) United States
(12) Patent Application Publication
(10) Pub. No.: US 2025/0171621 A1
(43) Pub. Date: May 29, 2025

(54) COMPOSITE RESIN FOR AESTHETIC RESTORATION WITH IMPROVED ANTIBACTERIAL PROPERTIES AND POLYMERIZATION DEPTH, ANTIBACTERIAL AND ANTIVIRAL 3D PRINTING DENTURE BASE RESIN COMPOSITION, AND METHODS FOR PREPARING THE SAME

(71) Applicant: In Sun JEONG, Gwangju (KR)

(72) Inventor: In Sun JEONG, Gwangju (KR)

(21) Appl. No.: 18/781,648

(22) Filed: Jul. 23, 2024

(30) Foreign Application Priority Data
Nov. 24, 2023 (KR) 10-2023-0165747
Nov. 30, 2023 (KR) 10-2023-0171422

(51) Int. Cl. C08K 13/02; C08K 3/36; C08K 3/40; C08K 5/05; C08K 5/17; C08L 35/02

(52) U.S. Cl. CPC C08K 13/02; C08L 35/02; C08K 3/36; C08K 3/40; C08K 5/05; C08K 5/175

(57) ABSTRACT

The present disclosure relates to a composite resin for aesthetic restoration with improved antibacterial properties and polymerization depth containing lysozyme, which comprises uethane dimethacrylate (UDMA), bisphenol A-glycidyl methacrylate (BIS-GMA), bisphenol A dimethacrylate ethoxylated (BIS-EMA), triethylene glycol dimethacrylate (TEGDMA), a photoinitiator, a photoinitiator aid, a filler, barium glass, an accelerator, an antioxidant, an anti-discoloration agent, and an antibacterial agent, and a method for preparing the same. The composite resin for aesthetic restoration may be applied as a bulk-fill resin due to improved polymerization depth, may secure resistance to bacteria or viruses due to excellent antibacterial properties, and may implement bending strength that exceeds 80 MPa, which is a level required by the Ministry of Food and Drug Safety, after polymerization.

### CROSS-REFERENCE TO RELATED APPLICATION(S)

This application claims benefit of priority to Korean Patent Application No. 10-2023-0165747 filed on 24 Nov. 2023 and Korean Patent Application No. 10-2023-0171422 filed on 30 Nov. 2023 in the Korean Intellectual Property Office, the disclosure of which is incorporated herein by reference in its entirety.

### BACKGROUND

### 1. Field

The present disclosure relates to a composite resin for aesthetic restoration with improved antibacterial properties and polymerization depth for use in dental treatment. In addition, the present disclosure relates to a denture base resin composition that may be used through a 3D printing process and has excellent antibacterial and antiviral properties.

### 2. Description of Related Art

In general, when teeth are damaged due to dental caries or fracture, or are lost due to missing teeth, etc., problems arise in pronunciation, chewing, and aesthetics arise. Further, when adjacent teeth move into an empty space where there are no teeth and a normal alignment of the teeth begins to become misaligned, food gets stuck between the teeth, result in secondary dental caries, gum disease, bad breath, etc.

To solve these problems and maintain and restore the function of oral cavity, dental restoration surgery is performed to replace part or all of the missing teeth using dental restorative resins.

Various materials have been used as these dental restorative resins, with mercury amalgam being the primary material used in the early days due to ease of procedure and excellent wear resistance and mechanical strength. However, it is known that amalgam has a distinct color difference from natural teeth, has poor adhesion to tooth tissue, and also may be harmful to the human body in the long term as mercury may gradually leak out over time after restoration.

Therefore, new materials that can replace amalgam have been developed, and recently, one of them, polymer materials, has been in the spotlight. The first polymer composite resin for dental restoration has been used clinically since 1942, when Kulzer in Germany developed a mixture of polymethylmethacrylate (PMMA) powders and methyl methacrylate (MMA) monomers, and acrylic resins have been used for a long time since then.

While these organic polymers have advantages such as aesthetics, simplicity of procedure, and low biohazard, they do not have sufficient hardness, strength, and abrasion resistance to withstand chewing pressure, etc. by their own physical properties alone, so composite resins mixed with inorganic fillers have been developed. Commercial composite resins for dental restoration were developed in a chemically initiated form by in 1962, following Brown by photopolymerization using ultraviolet light in the 1970s and photopolymerization using visible light in 1980 by ICI in the UK, the amount of these composite resins used for dental restoration has been increasing as they replaced existing amalgam. Recently, fluoride has been added to a composite resin for dental restoration to prevent secondary dental caries after restoration. Fluorine-added resin prevented secondary dental caries to some extent due to the antibacterial properties of fluoride, but fluorine-releasing materials may impair the adhesion of the resin.

On the other hand, a denture or an artificial tooth is a type of removable prosthesis that replaces the missing teeth and surrounding tissues when all natural teeth in the upper or lower jaw are lost. Unlike partial dentures, they function in the mouth only with the help of an alveolar ridge. Therefore, there is a problem of lack of retention, which is a force that prevents the denture or artificial teeth from falling out of the mouth, support, which is a force with which tissues in the mouth support a complete denture, and stability, which is a degree to which the complete denture does not move when chewing or speaking.

In general, heat-polymerized or self-polymerized resins using polymethyl methacrylate (PMMA) and methyl methacrylate (MMA) are mainly used as main raw materials for denture bases. However, these conventional denture base resin compositions have excellent transparency and high glass transition temperature, so they have excellent mechanical properties, but they are easily damaged by external forces due to their weak impact strength, and are prone to surface scratches and abrasion due to their low surface hardness and abrasion resistance.

Meanwhile, with the recent expansion of 3D printing market, 3D printing has been introduced to a dental field, making it possible to prepare denture bases optimized for an individual's oral structure. Denture base resin that may be applied to 3D printing needs to satisfy all properties such as mechanical properties, wear resistance, and transparency. However, it is not easy to secure mechanical properties due to the nature of 3D printing that makes products by stacking 3D ink in layers.

In addition, due to the long-term nature of wearing denture in the oral cavity, the surface of the denture base is easily exposed to various harmful bacteria or viruses, resulting in infection or inflammation, or secondary infection.

### SUMMARY

An object of the present disclosure is to provide a composite resin for aesthetic restoration with improved antibacterial properties and polymerization depth, and a method for preparing the same. Another object of the present disclosure is to provide a 3D printing denture base resin composition that may be applied to 3D printing and has antibacterial and antiviral performance, and a method for preparing the same.

According to an aspect of the present disclosure, there is provided a composite resin for aesthetic restoration containing urethane dimethacrylate (UDMA), bisphenol A-glycidyl methacrylate (BIS-GMA), bisphenol A dimethacrylate ethoxylated (BIS-EMA), triethylene glycol dimethacrylate (TEGDMA), a photoinitiator, a photoinitiator aid, a filler, barium glass, an accelerator, an antioxidant, an anti-discoloration agent, and an antibacterial agent, which has improved antibacterial properties and polymerization depth. The composite resin for aesthetic restoration may contain 2 to 5 parts by weight of a filler, 4 to 6 parts by weight of an antibacterial agent, and 40 to 45 parts by weight of barium glass, based on 100 parts by weight of the base composition containing 5 to 20 wt % of UDMA, 40 to 70 wt % of BIS-GMA, 15 to 30 wt % of BIS-EMA, 3 to 6 wt % of TEGDMA, 0.5 to 2.5 wt % of a photoinitiator, 0.02 to 0.2 wt % of a photoinitiator aid, 0.2 to 1 wt % of an accelerator, 0.05 to 0.5 wt % of an antioxidant, and 0.05 to 0.5 wt % of an anti-discoloration agent. Additionally, the antibacterial agent may contain or be lysozyme.

According to another aspect of the present disclosure, a method for preparing a composite resin for aesthetic restoration includes: a first step of preparing a polymer mixture by mixing UDMA, BIS-GMA, BIS-EMA, and TEGDMA; a second step of preparing a base composition by mixing the polymer mixture with a photoinitiator, a photoinitiator aid, an accelerator, an antioxidant, and an anti-discoloration agent; and a third step of preparing a composite resin by mixing the base composition with an antibacterial agent, a filler, and barium glass, wherein the composite resin for aesthetic restoration has improved antibacterial properties and polymerization depth. In addition, the antibacterial agent may contain or be lysozyme.

The composite resin prepared through the third step may contain 2 to 5 parts by weight of a filler, 4 to 6 parts by weight of an antibacterial agent, and 40 to 45 parts by weight of barium glass, based on 100 parts by weight of the base composition containing 5 to 20 wt % of UDMA, 40 to 70 wt % of BIS-GMA, 15 to 30 wt % of BIS-EMA, 3 to 6 wt % of TEGDMA, 0.5 to 2.5 wt % of a photoinitiator, 0.02 to 0.2 wt % of a photoinitiator aid, 0.2 to 1 wt % of an accelerator, 0.05 to 0.5 wt % of an antioxidant, and 0.05 to 0.5 wt % of an anti-discoloration agent.

The lysozyme may be a modified lysozyme that had undergone a modification process, wherein the modification process may include: a purification step of purifying a surface of lysozyme with ethanol; and a surface modification step of mixing surface-purified lysozyme and PEGDMA.

According to still another aspect of the present disclosure, there is provided an antibacterial and antiviral 3D printing denture base resin composition containing UDMA, BIS-GMA, BIS-EMA, TEGDMA, a photoinitiator, photoinitiator aids, a filler, an accelerator, an antioxidant, an anti-discoloration agent, and an antibacterial material.

Specifically, the antibacterial and antiviral 3D printing denture base resin composition may contain 5 to 20 wt % of UDMA, 40 to 70 wt % of BIS-GMA, 15 to 30 wt % of BIS-EMA, 3 to 5 wt % of TEGDMA, 0.5 to 2.5 wt % of a photoinitiator, 0.02 to 0.2 wt % of a photoinitiator aid, 2 to 6 wt % of a filler, 0.2 to 1 wt % of an accelerator, 0.05 to 0.5 wt % of an antioxidant, 0.05 to 0.5 wt % of an anti-discoloration agent, and 1 to 3 wt % of an antibacterial material, wherein, the antibacterial material may contain pectin and/or protamine.

According to still another aspect of the present disclosure, a method for preparing an antibacterial and antiviral 3D printing denture base resin composition includes: step a of preparing a second polymer mixture by mixing UDMA, BIS-GMA, BIS-EMA, and TEGDMA; step b of preparing a second base composition by mixing the polymer mixture with a photoinitiator, a photoinitiator aid, an accelerator, an antioxidant, and an anti-discoloration agent; and step c of preparing a resin composition by mixing the second base composition with an antibacterial material and a filler.

The resin composition prepared through step c may contain 5 to 20 wt % of UDMA, 40 to 70 wt % of BIS-GMA, 15 to 30 wt % of BIS-EMA, 3 to 5 wt % of TEGDMA, 0.5 to 2.5 wt % of a photoinitiator, 0.02 to 0.2 wt % of a photoinitiator aid, 2 to 6 wt % of a filler, 0.2 to 1 wt % of an accelerator, 0.05 to 0.5 wt % of an antioxidant, 0.05 to 0.5 wt % of an anti-discoloration agent, and 1 to 3 wt % of an antibacterial material, wherein the antibacterial material used may be pectin and/or protamine.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 illustrates the results of an antibacterial test of composite resins for aesthetic restoration according to an embodiment of the present disclosure; and

FIG. 2 illustrates the results of antibacterial evaluation of each of 3D printing denture base resin composition according to another embodiment of the present disclosure.

### DETAILED DESCRIPTION

Hereinafter, the present disclosure will be described in detail with reference to a preferred embodiment of the present disclosure.

Throughout the present specification, when a part “comprises” a certain component, this means that other components may be further included, rather than excluding other components, unless specifically stated to the contrary.

Throughout the present specification, “g” used to indicate the concentration of a particular substance means (weight/weight) % for solid/solid, (weight/volume) % for solid/liquid, and (volume/volume) % for liquid/liquid, unless otherwise stated.

An embodiment of the present disclosure relates to a composite resin for aesthetic restoration with improved antibacterial properties and polymerization depth and a method for preparing the same, wherein the composite resin for aesthetic restoration according to the present disclosure contains lysozyme. As a result, the composite resin for aesthetic restoration has antibacterial and antiviral properties and may counter various harmful bacteria and viruses. Also, the composite resin for aesthetic restoration does not contain fluorine-containing materials as a substance for antibacterial purposes, thereby preventing deterioration of the adhesiveness of the resin due to the addition of an antibacterial agent.

In addition, due to the increase in polymerization depth, a stacked thickness may be increased during restoration, thereby reducing the area of a stacked interface. Thus, secondary dental caries at the stacked interface may be prevented, and the convenience of the procedure may be improved by reducing the procedure time.

The composite resin for aesthetic restoration with improved antibacterial properties and polymerization depth according to an embodiment of the present disclosure contains UDMA, BIS-GMA, BIS-EMA, TEGDMA, a photoinitiator, a photoinitiator aid, a filler, barium glass, an accelerator, an antioxidant, an anti-discoloration agent, and an antibacterial agent.

Specifically, the composite resin for aesthetic restoration may contain 2 to 5 parts by weight of a filler, 4 to 6 parts by weight of an antibacterial agent, and 40 to 45 parts by weight of barium glass, based on 100 parts by weight of the base composition containing 5 to 20 wt % of UDMA, 40 to 70 wt % of BIS-GMA, 15 to 30 wt % of BIS-EMA, 3 to 6 wt % of TEGDMA, 0.5 to 2.5 wt % of a photoinitiator, 0.02 to 0.2 wt % of a photoinitiator aid, 0.2 to 1 wt % of an accelerator, 0.05 to 0.5 wt % of an antioxidant, and 0.05 to 0.5 wt % of an anti-discoloration agent.

The UDMA, BIS-GMA, BIS-EMA, and TEGDMA are polymer materials that form a basic structure of a restoration area made of composite resin. A photoinitiator and a photoinitiator aid are materials that initiate photocuring of these polymers. A filler, barium glass, an accelerator, an antioxidant, an anti-discoloration agent, and an antibacterial agent are a type of additive and are added to improve the physical and chemical properties of the restoration area prepared using composite resin.

The urethane dimethacrylate (UDMA) is added to reduce polymerization shrinkage and improve elasticity and toughness, and may be included in the composite resin in an amount of 5 to 20 wt %. If the content of UDMA is less than the above range, it is difficult to obtain the effect described above for UDMA. If the content of UDMA exceeds the above range, the content of BIS-GMA is relatively reduced, making it difficult to secure sufficient bending strength. Therefore, it is preferable that the UDMA is included within the weight range described above.

The bisphenol A-glycidyl methacrylate (BIS-GMA) includes two hydrophobic methacrylic groups, has low volatility and polymerization shrinkage, has fast curing, has a large molecular weight, and has high stability, and thus is suitable as a matrix resin. However, due to its high viscosity, it is difficult to stir it evenly with other ingredients and has poor workability, so it is used together with BIS-EMA to reduce its viscosity.

The BIS-GMA may be pure BIS-GMA, modified BIS-GMA, or a mixture containing both, wherein the modified BIS-GMA may contain at least one of 2,2-bis [3-methyl, 4-(2-hydroxy-3-methacryloyloxy propoxy)phenyl] propan (DMBIS-GMA) and 2,2-bis [3-methyl, 4-(2-hydroxy-3-methacryloyloxy propoxy)phenyl] propan (TMBIS-GMA). In particular, it is preferable to use modified BIS-GMA, which has significantly higher strength after curing to secure the strength of the restoration area, and most preferably DMBIS-GMA to secure more improved strength.

The BIS-GMA may be included in the total composition in an amount of 40 to 70 wt %. If the BIS-GMA is included in less than the above weight range, it is difficult to secure sufficient strength. If the BIS-GMA is included in excess of the above weight range, a uniform stirring process is difficult due to the excessively high viscosity. Therefore, it is preferable that the BIS-GMA is included within the weight range described above.

The bisphenol A dimethacrylate ethoxylated (BIS-EMA) is added to reduce the viscosity due to the use of BIS-GMA, and may be included in the composite resin in an amount of 15 to 30 wt %. If the BIS-EMA is included in less than the above weight range, sufficient viscosity reduction for uniform stirring is not achieved. If the BIS-EMA is included in excess of the above weight range, it is difficult to secure sufficient strength after curing, and excessive reduction in viscosity may result in a formulation that is difficult to apply to the desired thickness during restorative procedures. Therefore, it is preferable that the BIS-EMA is included within the weight range described above.

The triethylene glycol dimethacrylate (TEGDMA) is added as a viscosity modifier, and may be included in the total composition in an amount of 3 to 6 wt %. If the TEGDMA is included in less than the above weight range, the viscosity properties required for restorative procedures are not satisfied. If the TEGDMA is included in excess of the above weight range, there is a possibility that defects may occur due to excessive polymerization shrinkage. Therefore, it is preferable that the TEGDMA is included within the weight range described above.

The photoinitiator is a material characterized in that it is activated by light irradiation to form radicals. The radicals thus formed initiate the photopolymerization reaction of BIS-GMA, BIS-EMA, UDMA, and TEGDMA, resulting in a curing reaction of the composite resin. The photoinitiator is preferably included in the total composition in an amount of 0.5 to 2.5 wt % in order to cause a sufficient photo-curing reaction.

As such s photoinitiator, a curing agent for dental curing materials such as camphorquinone, 2,4,6-trimethyl benzoyl-diphenylphosphine oxide (TPO), and the like, for example, may be used. Any photoinitiator that may be applied to dental equipment or cured materials may be applied to the present disclosure without being limited to the types listed above. In particular, it is preferred that any one or more of camphorquinone or TPO may be used, and more preferably a mixture thereof to secure desirable curing properties and safety.

The photoinitiator aid is added to assist photoinitiation by a photoinitiator, and for example, diphenyliodonium hexafluorophosphate (DIFP) may be used, but is not limited thereto. The photoinitiator aid may be included in the total composition in an amount of 0.02 to 0.2 wt %.

The accelerator may be added to facilitate photoinitiation by increasing the efficiency of radical generation of the photoinitiator by light irradiation. As such an accelerators, at least one selected from the group consisting of ethyl (4-dimethyl amino)benzoate (EDMAB), 4-(dimethylamino) benzoic acid (DMABA), 4-(dimethylamino) benzaldehyde (DMABZR), 2-(dimethylamino) ethyl methacrylate (DMAEMA), 2-(dimethylamino) ethyl acrylate (DMAEA), 2-(diethylamino) ethyl methacrylate (DEAEMA), and 2-(diethylamino) ethyl acrylate (DEAEA), for example, may be used, but is not limited thereto. The accelerator may be included in the total composition in an amount of 0.2 to 1 wt %.

The antioxidant is added to prevent oxidative degradation of the composite resin or restoration area, and butylated hydroxy toluene (BHT) or the commercial products such as Irganox may be used, but are not limited thereto. The antioxidant may be included in the total composition in the range of 0.05 to 0.5 wt %.

The anti-discoloration agent is added to prevent discoloration caused by ultraviolet rays in the composite resin or restoration area, and anti-discoloration agents such as Tinuvin® and Tinopal® may be used. The anti-discoloration agent is preferably included in the composite resin in an amount of 0.05 to 0.5 wt % to achieve an anti-discoloration effect while preventing deterioration of the physical properties of the restoration area.

On the other hand, the composite resin for aesthetic restoration according to an embodiment of the present disclosure may contain 2 to 5 parts by weight of a filler, 4 to 6 parts by weight of an antibacterial agent, and 40 to 45 parts by weight of barium glass, based on 100 parts by weight of the base composition containing 5 to 20 wt % of UDMA, 40 to 70 wt % of BIS-GMA, 15 to 30 wt % of BIS-EMA, 3 to 6 wt % of TEGDMA, 0.5 to 2.5 wt % of a photoinitiator, 0.02 to 0.2 wt % of a photoinitiator aid, 0.2 to 1 wt % of an accelerator, 0.05 to 0.5 wt % of an antioxidant, and 0.05 to 0.5 wt % of an anti-discoloration agent.

The filler is added to improve the physical strength and wear resistance of the restoration area, and may be included in an amount of 2 to 5 parts by weight based on 100 parts by weight of the base composition. The filler is preferably included within the weight range described above, in order to prevent problems such as detachment of the filler or decrease in bonding strength due to an increase in the amount of filler while improving strength and durability caused by the filler.

As such a filler, silica, strontium aluminum silicate, barium aluminum silicate, kaolin, talc, radiopaque glass powder, and zirconia compounds, and the like, for example, may be used, but the types of fillers that may be applied in the present embodiment are limited thereto.

Preferably, silica surface-treated with a silane coupling agent may be used as a filler to improve miscibility with hydrophobic polymerization monomers. A method of modifying the surface of silica with a silane coupling agent and specific details of the silane coupling agent and a specific type of a silane coupling agent used for surface treatment are known in the art, and thus a detailed description thereof will be omitted.

In addition, it is preferable to use fillers whose particle size is adjusted to 50 μm or less through a micro-sizing process as this range of particle size prevents agglomeration of the filler, thereby reducing the space between the filler particles. Accordingly, the length of an effective path through which the crack can extend is increased when a microcrack occurs in the restoration area, so even if a microcrack occurs, it is not easily destroyed, thereby improving the durability of the restoration area.

The antibacterial agent may be included in the composite resin and added to provide antibacterial and antiviral functions. The antibacterial agent may be included in an amount of 4 to 6 parts by weight based on 100 parts by weight of the base composition. If the antibacterial agent is included in less than the above range, antibacterial and antiviral performance is s not guaranteed. If the antibacterial agent is included in excess of the above range, the content of other ingredients may be relatively reduced, resulting in functional degradation, or in particular, the compatibility of radiopacity required by the Ministry of Food and Drug Safety may be impaired due to the reduction of barium glass. Therefore, it is preferable that the antibacterial agent is included within the weight range described above.

The antibacterial agent may contain lysozyme. Lysozyme is a substance contained in egg white, animal tissue, body fluid, etc., and has antibacterial activity by hydrolyzing the beta bonds of some polysaccharides among the cell wall components of bacteria and destroying the cell wall. It is included in the composite resin according to the present disclosure and plays a role in imparting antibacterial properties to the restoration area to which the composite resin is applied.

Lysozyme, which has not been treated separately, is highly hygroscopic and may promote changes in physical properties such as resin discoloration caused by food and contaminants in the oral cavity. Therefore, it is preferable to use modified lysozyme that had undergone a modification process as an antibacterial agent for the composite resin according to the present disclosure. In addition, lysozyme, which had undergone a modification process to be described later, may be used as a bulk-fill type composite resin by improving the polymerization depth of the composite resin.

The modification process for preparing modified lysozyme may include: a purification step of purifying a surface of lysozyme with ethanol; and a surface modification step of mixing surface-purified lysozyme and polyethylene glycol dimethacrylate (PEGDMA). The specific method will be described in detail in specific examples related to the preparing method to be described later.

The barium glass is added to secure radiopacity compatibility of the restoration area, and may be included in an amount of 40 to 45 parts by weight based on 100 parts by weight of the base composition.

On the other hand, another embodiment of the present disclosure includes a method for preparing a composite resin for aesthetic restoration with improved antibacterial properties and polymerization depth. According to the present embodiment, the composite resin for aesthetic restoration with improved antibacterial properties and polymerization depth described above may be prepared. Therefore, some overlapping explanations will be omitted.

A method for preparing a composite resin for aesthetic restoration with improved antibacterial properties and polymerization depth according to another embodiment of the present disclosure includes: a first step of preparing a polymer mixture by mixing UDMA, BIS-GMA, BIS-EMA, and TEGDMA; a second step of preparing a base composition by mixing the polymer mixture with a photoinitiator, a photoinitiator aid, an accelerator, an antioxidant, and an anti-discoloration agent; and a third step of preparing a composite resin by mixing the base composition with an antibacterial agent, a filler, and barium glass.

Each of the first step, the second step, and the third step is a step of sequentially mixing raw materials, wherein the mixing in each mixing step may be performed at a stirring speed of 5 to 15 rpm at 30 to 60° C., and may be performed under reduced pressure conditions with a vacuum gauge pressure of 0.05 to 0.2 MPa to prevent bubble generation during stirring.

The first step is a step of preparing a polymer mixture by mixing UDMA, BIS-GMA, BIS-EMA, and TEGDMA.

This step is a step of mixing 5 to 20 wt % of UDMA, 40 to 70 wt % of BIS-GMA, 15 to 30 wt % of BIS-EMA, and 3 to 6 wt % of TEGDMA, wherein the composition ratio refers to a weight ratio in the base composition containing UDMA, BIS-GMA, BIS-EMA, TEGDMA, a photoinitiator, a photoinitiator aid, an accelerator, an antioxidant, and an anti-discoloration agent. In this step, stirring may be performed for 30 to 100 minutes, and the stirring time may vary depending on the season. Within the above range of stirring time, stirring may be performed for a short time in summer and for a long time in winter.

Additionally, the first step may be performed under light irradiation, wherein the wavelength of the light source is 330 to 510 nm, which may vary depending on the absorption wavelength of the photoinitiator. For example, when camphorquinone is used as a photoinitiator, light of 450 to 480 nm may be irradiated, and when TPO is used, light of 350 to 430 nm may be irradiated.

In addition, as described above, since a vacuum is applied during a stirring process, the generation of bubbles is prevented, thereby reducing light bending due to bubbles, and thus increasing the exposed area of a raw material mixture to the light source, allowing for more efficient and effective light irradiation.

As the first step is thus performed under light irradiation conditions on a polymer mixture that does not contain a photoinitiator, the polymer mixture is photoreactively modified, and during subsequent photocuring, the polymer is activated more quickly and better by light, so that the quality of the restoration area, which is a cured body, may be improved.

The second step is a step of preparing a base composition by mixing the polymer mixture with photoinitiator, a photoinitiator aid, an accelerator, an antioxidant, and an anti-discoloration agent. These ingredients are the same as those previously described in an embodiment of the present disclosure, and each raw material may be mixed in this step such that the base composition contains 0.5 to 2.5 wt % of a photoinitiator, 0.02 to 0.2 wt % of a photoinitiator aid, 0.2 to 1 wt % of an accelerator, 0.05 to 0.5 wt % of an antioxidant, and 0.05 to 0.5 wt % of an anti-discoloration agent.

The third step is a step of preparing a composite resin by mixing the base composition with an antibacterial agent and a filler. Specifically, the third step may be a step of mixing 100 parts by weight of the base composition, 2 to 5 parts by weight of a filler, 4 to 6 parts by weight of an antibacterial agent, and 40 to 45 parts by weight of barium glass, and then aging the mixture at 31.5 to 65° C. for 48 hours or more. This aging may stabilize the surface of the activated filler and barium glass, restore some of the basic physical properties of the polymer damaged during the stirring process, and strengthen the cross-linking between the polymer and filler, thereby stabilizing the physical properties of the composite resin.

The composite resin prepared through the third step may contain 2 to 5 parts by weight of a filler, 4 to 6 parts by weight of an antibacterial agent, and 40 to 45 parts by weight of barium glass, based on 100 parts by weight of the base composition containing 5 to 20 wt % of UDMA, 40 to 70 wt % of BIS-GMA, 15 to 30 wt % of BIS-EMA, 3 to 6 wt % of TEGDMA, 0.5 to 2.5 wt % of a photoinitiator, 0.02 to 0.2 wt % of a photoinitiator aid, 0.2 to 1 wt % of an accelerator, 0.05 to 0.5 wt % of an antioxidant, and 0.05 to 0.5 wt % of an anti-discoloration agent.

The antibacterial agent may contain lysozyme, wherein the lysozyme may be modified lysozyme that had undergone a modification process. Lysozyme, which has not been treated separately, is highly hygroscopic and may promote changes in physical properties such as resin discoloration caused by food and contaminants in the oral cavity. Therefore, it is preferable to use modified lysozyme that had undergone a modification process as an antibacterial agent for the composite resin.

The modification process for preparing modified lysozyme may include: a purification step of purifying a surface of lysozyme with ethanol; and a surface modification step of mixing surface-purified lysozyme and polyethylene glycol dimethacrylate (PEGDMA).

The purification step is a step of purifying lysozyme by removing oil from the surface of lysozyme particles, and may include: a first step of mixing lysozyme and ethanol and stirring the mixture in a sealed container; and a second step of evaporating ethanol by opening the sealed container and stirring the mixture.

The first step is a step of mixing lysozyme and ethanol and stirring the mixture in a sealed container, wherein ethanol used in this step may be a 90 to 99% aqueous solution, and the mixture may be mixed in a ratio of 20 to 30 wt % of lysozyme and 70 to 80 wt % of ethanol and stirred at 4 to 5 rpm for 4 to 8 hours. This step may allow impurities such as oil on the surface of lysozyme to be dissolved in ethanol.

The second step may be a step of opening the sealed container containing the lysozyme and ethanol that had undergone the first step, and evaporating ethanol by stirring the mixed solution of the lysozyme and ethanol. This step may be performed by opening the sealed container and stirring the mixed solution at 2 to 3 rpm until the ethanol evaporates. This purification step may be performed once, or may also be repeated two or three times.

Next, a surface modification step of mixing the surface-purified lysozyme obtained through the above purification step and polyethylene glycol dimethacrylate (PEGDMA) is performed. This step may be a step of mixing 65 to 70 wt % of the purified lysozyme and 30 to 35 wt % of PEGDMA, and stirring the mixture of lysozyme and PEGDMA at 3 to 4 rpm under reduced pressure conditions with a vacuum gauge pressure of 0.05 to 0.2 MPa and a temperature condition of 30 to 40° C., wherein stirring may be performed for 10 to 18 hours.

The modified lysozyme obtained through this process loses its moisture absorption properties, thereby preventing discoloration and degeneration of the restoration area due to moisture absorption.

As such, the composite resin for aesthetic restoration containing lysozyme, which has improved antibacterial properties and polymerization depth according to an embodiment of the present disclosure, may be applied as a bulk-fill resin due to its improved polymerization depth, may secure resistance against bacteria and viruses due to its excellent antibacterial properties, and may achieve a bending strength that exceeds 80 MPa, which is the level required by the Ministry of Food and Drug Safety, after polymerization.

Another embodiment of the present disclosure includes an antibacterial and antiviral 3D printing denture base resin composition and a method for preparing the same. The denture base prepared with the 3D printing denture base resin composition according to the present disclosure, has antibacterial and antiviral performance while satisfying 65 MPa, which is the standard of bending strength of 3D printing denture base resin required by the Ministry of Food and Drug Safety.

The 3D printing denture base resin composition according to the present disclosure contains UDMA, BIS-GMA, BIS-EMA, TEGDMA, a photoinitiator, a photoinitiator aid, a filler, an accelerator, an antioxidant, an anti-discoloration agent, and an antibacterial material.

Specifically, the 3D printing denture base resin composition may contain 5 to 20 wt % of UDMA, 40 to 70 wt % of BIS-GMA, 15 to 30 wt % of BIS-EMA, 3 to 5 wt % of TEGDMA, 0.5 to 2.5 wt % of a photoinitiator, 0.02 to 0.2 wt % of a photoinitiator aid, 2 to 6 wt % of a filler, 0.2 to 1 wt % of an accelerator, 0.05 to 0.5 wt % of an antioxidant, 0.05 to 0.5 wt % of an anti-discoloration agent, and 1 to 3 wt % of an antibacterial material.

The UDMA, BIS-GMA, BIS-EMA, and TEGDMA are polymer materials that form a basic structure of a denture base prepared using a resin composition. A photoinitiator and a photoinitiator aid are materials that initiate photocuring of these polymers. A filler, an accelerator, an antioxidant, an anti-discoloration agent, and an antibacterial material are a type of additive and are added to improve the physical and chemical properties of a denture base prepared using a resin composition.

The urethane dimethacrylate (UDMA) is added to reduce polymerization shrinkage and improve elasticity and toughness, and may be included in the resin composition in an amount of 5 to 20 wt %. If the content of UDMA is less than the above range, it is difficult to obtain the effect described above for UDMA. If the content of UDMA exceeds the above range, the content of BIS-GMA is relatively reduced, making it difficult to secure sufficient bending strength. Therefore, it is preferable that the UDMA is included within the weight range described above.

The bisphenol A-glycidyl methacrylate (BIS-GMA) includes two hydrophobic methacrylic groups, has low volatility and polymerization shrinkage, has fast curing, has a large molecular weight, and has high stability, and thus is suitable as a matrix resin. However, due to its high viscosity, it is difficult to stir it evenly with other ingredients and has poor workability, so it is used together with BIS-EMA to reduce its viscosity.

The BIS-GMA may be pure BIS-GMA, modified BIS-GMA, or a mixture containing both, wherein the modified BIS-GMA may contain at least one of 2,2-bis [3-methyl, 4-(2-hydroxy-3-methacryloyloxy propoxy)phenyl] propan (DMBIS-GMA) and 2,2-bis [3-methyl, 4-2-hydroxy-3-methacryloyloxy propoxy) phenyl]propan (TMBIS-GMA). In particular, it is preferable to use modified BIS-GMA, which has significantly higher strength after curing to secure the strength of the denture base, and most preferably DMBIS-GMA to secure more improved strength.

The BIS-GMA may be included in the total composition in an amount of 40 to 70 wt %. If the BIS-GMA is included in less than the above weight range, it is difficult to secure sufficient strength. If the BIS-GMA is included in excess of the above weight range, a uniform stirring process is difficult due to the excessively high viscosity. Therefore, it is preferable that the BIS-GMA is included within the weight range described above.

The bisphenol A dimethacrylate ethoxylated (BIS-EMA) is added to reduce the viscosity due to the use of BIS-GMA, and may be included in the resin composition in an amount of 15 to 30 wt %. If the BIS-EMA is included in less than the above weight range, sufficient viscosity reduction for uniform stirring is not achieved. If the BIS-EMA is included in excess of the above weight range, it is difficult to secure sufficient strength after curing, and excessive reduction in viscosity may result in a formulation that is difficult to apply to 3D printing. Therefore, it is preferable that the BIS-EMA is included within the weight range described above.

The triethylene glycol dimethacrylate (TEGDMA) added as a viscosity modifier for application to 3D printing, and may be included in the total composition in an amount of 3 to 5 wt %. If the TEGDMA is included in less than the above weight range, the viscosity properties required for 3D printing are not satisfied. If the TEGDMA is included in excess of the above weight range, there is a possibility that defects may occur due to excessive polymerization shrinkage. Therefore, it is preferable that the TEGDMA is included within the weight range described above.

The photoinitiator is a material characterized in that it is activated by light irradiation to form radicals. The radicals thus formed initiate the photopolymerization reaction of BIS-GMA, BIS-EMA, UDMA, and TEGDMA, resulting in a curing reaction of the resin composition. It is preferable that the the photoinitiator is included in the total composition in an amount of 0.5 to 2.5 wt % in order to cause a sufficient photo-curing reaction.

As such a photoinitiator, a curing agent for dental curing materials such as camphorquinone, 2,4,6-trimethyl benzoyl-diphenylphosphine oxide (TPO), and the like, for example, may be used. Any photoinitiator that may be applied to dental equipment or cured materials may be applied to the present disclosure without being limited to the types listed above. In particular, it is preferable that any one or more of camphorquinone or TPO may be used, and more preferably a mixture thereof to secure desirable curing properties and safety.

The photoinitiator aid is added to assist photoinitiation by a photoinitiator, and for example, diphenyliodonium hexafluorophosphate (DIFP) may be used, but is not limited thereto. The photoinitiator aid may be included in the total composition in an amount of 0.02 to 0.2 wt %.

The filler is added to improve the physical strength and wear resistance of the denture base, and may be included in the total composition in a weight range of 2 to 6 wt %. It is preferable that the filler is included within the weight range described above to obtain strength and durability enhancing effect caused by the filler, while preventing problems such as the detachment of the filler or deterioration of bonding strength due to an increase in the amount of filler.

As such a filler, silica, strontium aluminum silicate, barium aluminum silicate, barium glass, kaolin, talc, radiopaque glass powder, and zirconia compounds, and the like, for example, may be used, but the types of fillers that may be applied in the present embodiment are limited thereto.

Preferably, silica surface-treated with a silane coupling agent may be used as a filler to improve miscibility with hydrophobic polymerization monomers. A method of modifying the surface of silica with a silane coupling agent, and a specific type of a silane coupling agent used for surface treatment are known in the art, and thus a detailed description thereof will be omitted.

In addition, it is preferable to use fillers whose particle size is adjusted to 50 μm or less through a microsizing process, as this range of particle size prevents agglomeration of the filler and reduces the space between the filler particles. Accordingly, the length of an effective path through which the crack can extend is increased when a microcrack occurs in the denture base, so even if a microcrack occurs, it is not easily destroyed, thereby improving the durability of the denture base.

The accelerator may be added to facilitate photoinitiation by increasing the efficiency of radical generation of the photoinitiator by light irradiation. As such an accelerators, at least one selected from the group consisting of ethyl (4-dimethyl amino)benzoate (EDMAB), 4-(dimethylamino) benzoic acid (DMABA), 4-(dimethylamino) benzaldehyde (DMABZR), 2-(dimethylamino) ethyl methacrylate (DMAEMA), 2-(dimethylamino) ethyl acrylate (DMAEA), 2-(diethylamino) ethyl methacrylate (DEAEMA), and 2-(diethylamino) ethyl acrylate (DEAEA), for example, may be used, but is not limited thereto. The accelerator may be included in the total composition in an amount of 0.2 to 1 wt %.

The antioxidant is added to prevent oxidative degradation of the denture base resin composition or the denture base, and butylated hydroxy toluene (BHT) or the commercial products such as Irganox may be used, but are not limited thereto. The antioxidant may be included in the total composition in an amount of 0.05 to 0.5 wt %.

The anti-discoloration agent is added to prevent discoloration caused by ultraviolet rays in the denture base resin composition or in the denture base formed by 3D printing the same, and anti-discoloration agents such as trade names Tinuvin® and Tinopal® may be used. It is preferable that the anti-discoloration agent is included in the resin composition in an amount of 0.05 to 0.5 wt % to achieve an anti-discoloration effect while preventing deterioration of the physical properties of the denture base.

The antibacterial material may be included in the denture base resin composition and added to provide antibacterial and antiviral functions. The antibacterial material may be included in the resin composition in an amount of 1 to 3 wt %. If the antibacterial material is included in less than the above range, antibacterial and antiviral performance is not guaranteed. If the antibacterial material is included in excess of the above range, the strength of the denture base is lowered, and particular, the denture base resin composition has a bending strength of less than 65 MPa, which is the standard of bending strength of 3D printing denture base resin required by the Ministry of Food and Drug Safety. Therefore, it is preferable that the antibacterial material is included within the weight range described above.

The antibacterial material may contain at least one of pectin and protamine, preferably encapsulated pectin and protamine.

The pectin is a component containing one or more of pectin and a pectin decomposition product, wherein the pectin decomposition product may be a pectin decomposition product obtained by decomposing pectin with an enzyme (pectinase). This pectin decomposition product has a sterilizing effect and an inhibitory effect on the proliferation of bacteria or viruses, which is due to the action of oligomers and polymers of galacturonic acid contained in the pectin decomposition product.

The protamine has antibacterial performance against fungi such as bacteria, molds, and yeast, and antiviral performance against viruses.

Pectin and protamine with antibacterial and antiviral performance, are included in the resin composition and exhibit antibacterial and antiviral performance. However, if they are included in the resin composition without a separate treatment process such as encapsulation, there is a problem in that the antibacterial and antiviral functions are degraded or the effective period of these functions is shortened due to damage or movement of the antibacterial agent during the preparing process or during use of the denture base. Therefore, it is preferable to encapsulate pectin and protamine and use them.

The encapsulated pectin and protamine may be obtained by an encapsulation method, the method including: preparing a first precursor by mixing pectin, protamine, and collagen and then freeze-drying the mixture; preparing a second precursor by thawing, stirring, and freeze-drying the first precursor; preparing a third precursor by mixing the second precursor and phospholipids and then freeze-drying the mixture; and thawing the third precursor. The specific method will be described with reference to other embodiments of the present disclosure to be described later.

Meanwhile, another embodiment of the present disclosure includes a method for preparing an antibacterial and antiviral 3D printing denture base resin composition, and the antibacterial and antiviral 3D printing denture base resin composition described above may be prepared according to the present embodiment. Therefore, some overlapping description will be omitted.

The method for preparing an antibacterial and

antiviral 3D printing denture base resin composition according to the present embodiment includes: a first step of preparing a second polymer mixture by mixing UDMA, BIS-GMA, BIS-EMA, and TEGDMA; a second step of preparing a second base composition by mixing the second polymer mixture with a photoinitiator, a photoinitiator aid, an accelerator, an antioxidant, and an anti-discoloration agent; and a third step of preparing a resin composition by mixing the second base composition with an antibacterial material and a filler.

Each of the first step, the second step, and the third step is a step of sequentially mixing raw materials, wherein the mixing in each mixing step may be performed at a stirring speed of 5 to 15 rpm at 30 to 60° C., and may be performed under reduced pressure conditions with a vacuum gauge pressure e of 0.05 to 0.2 MPa to prevent bubble generation during stirring.

The first step is a step of preparing a second polymer mixture by mixing UDMA, BIS-GMA, BIS-EMA, and TEGDMA This step is a step of mixing 5 to 20 wt % of UDMA, 40 to 70 wt % of BIS-GMA, 15 to 30 wt % of BIS-EMA, and 3 to 5 wt % of TEGDMA, wherein the composition ratio refers to a weight ratio in the final resin composition. In this step, stirring may be performed for 30 to 100 minutes, and the stirring time may vary depending on the season. Within the above range of stirring time, stirring may be performed for a short time in summer and for a long time in winter.

Additionally, the first step may be performed under light irradiation, wherein the wavelength of the light source is 330 to 510 nm, which may vary depending on the absorption wavelength of the photoinitiator. For example, when camphorquinone is used as a photoinitiator, light of 450 to 480 nm may be irradiated, and when TPO is used, light of 350 to 430 nm may be irradiated. In addition, as described above, since a vacuum is applied during a stirring process, the generation of bubbles is prevented, thereby reducing light bending due to bubbles, and thus increasing the exposed area of a raw material mixture to the light source, allowing for more efficient and effective light irradiation.

As the first step is thus performed under light irradiation conditions on a polymer mixture that does not contain a photoinitiator, the polymer mixture is photoreactively modified, and during subsequent photocuring, the polymer is activated more quickly and better by light, so that the quality of the denture base, which is a cured body, may be improved.

The second step is a step of preparing a second base composition by mixing the second polymer mixture with a photoinitiator, a photoinitiator aid, an accelerator, an antioxidant, and an anti-discoloration agent. These ingredients are the same as those previously described, and each raw material may be mixed in this step such that the final resin composition contains 0.5 to 2.5 wt % of a photoinitiator, 0.02 to 0.2 wt % of a photoinitiator aid, 2 to 6 wt % of a filler, 0.2 to 1 wt % of an accelerator, 0.05 to 0.5 wt % of an antioxidant, and 0.05 to 0.5 wt % of an anti-discoloration agent.

The third step is a step of preparing a resin composition by mixing the second base composition with an antibacterial material and a filler. Specifically, this step may be a step of mixing the second base composition, an antibacterial material, and a filler, and then aging the mixture at 31.5 to 65° C. for more than 48 hours. This aging may stabilize the surface of the activated filler, restore some of the basic physical properties of the polymer damaged during the stirring process, and strengthen the cross-linking between the polymer and filler, thereby stabilizing the physical properties of the resin composition.

The resin composition prepared through the third step may be a 3D printing denture base resin composition according to an embodiment of the present disclosure, wherein the 3D printing denture base resin composition contains 5 to 20 wt % of UDMA, 40 to 70 wt % of BIS-GMA, 15 to 30 wt % of BIS-EMA, 3 to 5 wt % of TEGDMA, 0.5 to 2.5 wt % of a photoinitiator, 0.02 to 0.2 wt % of a photoinitiator aid, 2 to 6 wt % of a filler, 0.2 to 1 wt % of an accelerator, 0.05 to 0.5 wt % of an antioxidant, 0.05 to 0.5 wt % of an anti-discoloration agent, and 1 to 3 wt % of an antibacterial material.

The antibacterial material may contain pectin and protamine, preferably encapsulated pectin and protamine.

The pectin is a component containing one or more of pectin and a pectin decomposition product, wherein the pectin decomposition product may be a pectin decomposition product obtained by decomposing pectin with an enzyme (pectinase). This pectin decomposition product has a sterilizing effect and an inhibitory effect on the proliferation of bacteria or viruses, which is due to the action of oligomers and polymers of galacturonic acid contained in the pectin decomposition product.

The protamine has antibacterial performance against fungi such as bacteria, molds, and yeast, and antiviral performance against viruses.

Pectin and protamine with antibacterial and antiviral performance, are included in the resin composition and exhibit antibacterial and antiviral performance. However, if they are included in the resin composition without a separate treatment process such as encapsulation, there is a problem in that the antibacterial and antiviral functions are degraded or the effective period of these functions is shortened due to damage or movement of the antibacterial agent during the preparing process or during use of the denture base. Therefore, it is preferable to encapsulate pectin and protamine and use them.

The encapsulated pectin and protamine may be obtained by an encapsulation method including: preparing a first precursor by mixing pectin, protamine, and collagen and then freeze-drying the mixture; preparing a second precursor by thawing, stirring, and freeze-drying the first precursor; preparing a third precursor by mixing the second precursor and phospholipids and then freeze-drying the mixture; and thawing the third precursor.

First, the step of preparing the first precursor may be a step of preparing a first precursor by mixing pectin, protamine, and collagen and then freeze-drying the mixture, and may be step of mixing pectin, protamine, and collagen in a weight ratio of 1:1 to 7:0.9 to 4, preferably in a weight ratio of 1:1.3 to 6:1 to 3, and then freeze-drying the mixture.

In this step, mixing may be performed under a vacuum and stirring may be performed for 5 to 7 hours at 57 to 65° C. at a stirring speed of 4 to 5 rpm for uniform stirring. Further, in this step, freeze-drying may be performed for 10 to 17 hours at 0° C. or less.

Next, the step of preparing the second precursor is a step of preparing the second precursor by naturally thawing the first precursor at room temperature, stirring the thawed first precursor, and then freeze-drying it again. In this step, stirring may be performed for 10 to 15 hours at a stirring speed of 3 to 4 rpm under a vacuum and an environment of 67 to 74° C., and then freeze-dried for 20 to 30 hours at 0° C. or less to prepare the second precursor.

Next, a step of preparing a third precursor is performed. This step is where actual encapsulation is achieved by mixing the second precursor and the phospholipid and then freeze-drying the mixture. The second precursor and phospholipids may be mixed in a weight ratio of 1:0.8 to 1.5. Here, stirring may be performed for 10 to 15 hours at a stirring speed of 3 to 4 rpm under a vacuum and a condition of 65 to 75° C. for uniform mixing. The mixture obtained through these steps may be freeze-dried for 20 to 30 hours at 0° C. or less to prepare a third precursor.

The third precursor thus prepared may be thawed to obtain encapsulated pectin and protamine.

In this process of repeated freeze-drying, thawing, and mixing cycles, pectin and protamine, pectin and protamine, which are functional materials with antibacterial and antiviral performance, are effectively encapsulated, mixed with the resin composition, prepared into denture base, and prevent damage and movement of antibacterial materials in the process of use, so that the antibacterial properties of these functional materials may be maintained for a long time.

As such, the 3D printing denture base resin composition according to an embodiment of the present disclosure may be cured into the form of a denture base by being irradiated with light during the 3D printing process or after completion of 3D printing. After curing, the 3D printing denture base resin composition may achieve a bending strength of 65 MPa or more, which is the bending strength of denture bases required by the Ministry of Food and Drug Safety.

In addition, since the 3D printing denture base resin composition has antibacterial and antiviral properties, it is possible to secure resistance against bacterial or viral contamination of the denture base that is repeatedly removed from oral cavity and thus secondary infections.

Hereinafter, specific actions and effects of the present disclosure will be described with reference to specific embodiments of the present disclosure. However, this is presented as a preferred example of the present disclosure, and the scope of the present disclosure is not limited by the examples.

### Preparation Example 1

First, UDMA, BIS-GMA, BIS-EMA, and TEGDMA were placed in a vacuum mixer and stirred at 45° C. under 10 rpm and a vacuum gauge pressure of 0.07 MPa to prepare a polymer mixture. Then, a photoinitiator (Camphorquinone), a photoinitiator aid (DIFP), an accelerator (EDMAB), an antioxidant (BHT), and an anti-discoloration agent (Tinuvin) were added thereto, and stirred at the same temperature, stirring speed, and vacuum to prepare a base composition. The composition of the base composition thus prepared is shown in Table 1.

Subsequently, 4 parts by weight of an antibacterial agent, 4 parts by weight of a filler (silica), and 40 parts by weight of barium glass based on 100 parts by weight of the base composition, were added to a vacuum mixer containing the base composition, and stirred under the same conditions to prepare a uniform composition. Then, the obtained composition was aged for 50 hours at 33° C. to prepare a composite resin for aesthetic restoration with improved antibacterial properties and polymerization depth.

As the antibacterial agent, modified lysozyme that had undergone a purification step and a surface modification step was used. The purification step may be performed by mixing the lysozyme powder with an aqueous 95% ethanol solution in a weight ratio of 25:75, placed the mixture in a sealed container, mixed at 5 rpm for 6 hours at room temperature. Then, the sealed container was opened and the mixture mixed again at 2 rpm to evaporate the ethanol. The purification step was performed a total of two times. The surface modification step was performed by mixing lysozyme that had a purification step and PEGDMA in a weight ratio of 65:35 and stirring the mixture at 3 rpm for 12 hours under a vacuum of 0.05 MPa and a temperature of 35° C.

TABLE 1

| Raw material name | Content (wt %) |
|---|---|
| UDMA | 7.9 |
| BIS-GMA | 60.5 |
| BIS-EMA | 24.8 |
| TEGDMA | 4.3 |
| Photoinitiator | 1.3 |
| Photoinitiator aid | 0.1 |
| Accelerator | 0.6 |
| Antioxidant | 0.3 |
| Anti-discoloration agent | 0.2 |
| Total | 100 |

### Experimental Example 1

Composite resins with various compositions were prepared in the same manner as in Preparation Example 1, except that the content of the antibacterial agent in the composite resin was changed to 1 to 5 parts by weight based on 100 parts by weight of the base composition. Afterwards, each composite resin was then prepared to a size of 64 mm×10 mm×3.3 mm and then photocured to prepare five specimens each.

Each specimen was mounted on a universal material testing machine and bent at a speed of 5 mm/min until fracture, the load at fracture (F) was recorded, and the height (h) and breadth (b) of the specimen were measured. Then, the bending strength (OB) was calculated using the following Equation 1. In Equation 1, “l” refers to a distance between the supports of the universal material testing machine. Five specimens were prepared for each sample, the experiment was performed, and the bending strength was calculated. Thereafter, the results and average values are shown in Table 2.

$${σ}_{B} = \frac{3 Fl}{2 {bh}^{2}} \qquad [ Equation 1 ]$$

TABLE 2

| | Antibacterial agent content (parts by weight) | | | | |
|---|---|---|---|---|---|
| | 1 | 2 | 3 | 4 | 5 |
| Bending | 101.2 | 102.4 | 103.2 | 98.3 | 105.3 |
| strength | 98.2 | 97.5 | 101.1 | 110.1 | 102.1 |
| (MPa) | 97.5 | 103.2 | 97.3 | 114.6 | 102.6 |
| | 101.3 | 101.2 | 99.5 | 100.2 | 101.4 |
| | 92.3 | 97.5 | 103.5 | 105.2 | 109.2 |
| Average | 98.1 | 100.4 | 100.9 | 105.7 | 104.1 |

According to the results in Table 2 above, it was found that all specimens satisfied 80 MPa or more, which is the requirement standard for bending strength of the composite resin for aesthetic restoration by the Ministry of Food and Drug Safety, and had significantly higher bending strength than the requirement standard. In addition, it was found that there was a slight increase in bending strength as the content of antibacterial agent increased.

### Experimental Example 2

The specimen was prepared in the same manner as in Experimental Example 1, except that the content of the antibacterial agent was adjusted to 1 to 5 parts by weight relative to 100 parts by weight of the base composition, and an experiment was performed to measure the polymerization depth of each specimen in accordance with ISO 4049:2019 (E), Dentistry-polymer-based restorative materials, paragraphs 7 and 10. The results are shown in Table 3.

TABLE 3

| | Antibacterial agent content (parts by weight) | | | | |
|---|---|---|---|---|---|
| | 1 | 2 | 3 | 4 | 5 |
| Polymerization | 1.5 | 1.8 | 2.3 | 3.0 | 3.1 |
| depth (mm) | 1.8 | 1.7 | 2.1 | 3.2 | 3.1 |
| | 1.7 | 1.5 | 2.4 | 3.1 | 3.2 |
| | 1.8 | 1.6 | 2.9 | 3.3 | 3.4 |
| | 1.6 | 1.9 | 2.7 | 3.2 | 3.5 |
| Average | 1.68 | 1.70 | 2.48 | 3.16 | 3.26 |

According to the experimental results in Table 3, the antibacterial agent content and polymerization depth were found to be proportional. Even if the content of the antibacterial agent content exceeds 5 parts by weight, the antibacterial agent content and polymerization depth are expected to be proportional. Therefore, it could be confirmed that it was desirable to increase the content of antibacterial agent to improve polymerization depth, and in particular, it was desirable to add 4 parts by weight or more of the antibacterial agent to ensure a polymerization depth of 3 mm or more, which is the recognized range of polymerization depth for a bulk-fill resin.

### Experimental Example 3

Composite resin samples were prepared using modified lysozyme and a fluorine compound (NaF)) as antibacterial agents, respectively. The adhesive strength according to the antibacterial agent content with respect to 100 parts by weight of the base composition of each sample was evaluated and the results are shown in Table 4.

A specimen block was prepared by embedding bovine teeth in a composite resin block, the composite resin block was fixed with a holder, and then a tensile force was applied until the bovine teeth were dislodged to evaluate the tensile force at the time the bovine teeth were dislodged as adhesive strength.

TABLE 4

| | Modified lysozyme content | | | Fluorine content | | |
|---|---|---|---|---|---|---|
| | (parts by weight) | | | (parts by weight) | | |
| | 1 | 2 | 4 | 1 | 2 | 4 |
| Adhesive | 101.2 | 102.4 | 98.3 | 94.5 | 92.4 | 71.5 |
| strength | 98.2 | 97.5 | 110.1 | 88.8 | 88.5 | 72.9 |
| (MPa) | 97.5 | 103.2 | 114.6 | 87.5 | 82.8 | 74.2 |
| | 101.3 | 101.2 | 100.2 | 88.9 | 84.5 | 75.8 |
| | 92.3 | 97.5 | 105.2 | 91.5 | 83.2 | 73.1 |
| Average | 98.10 | 100.36 | 105.68 | 90.24 | 86.28 | 73.50 |

As confirmed in the results in Table 4 above, it was found that the use of modified lysozyme as an antibacterial agent resulted in a more improved adhesive strength than the use of fluorine compounds. In addition, in the case of fluorine compounds, the adhesive strength decreased as the content increased, but in the case of modified lysozyme, the adhesive strength increased slightly as the content increased.

Therefore, it could be confirmed that it is preferable to use modified lysozyme rather than a fluorine compound as an antibacterial agent used in dental resin in order to improve antibacterial ability and prevent a decrease in adhesion due to the use of antibacterial agents.

### Experimental Example 4

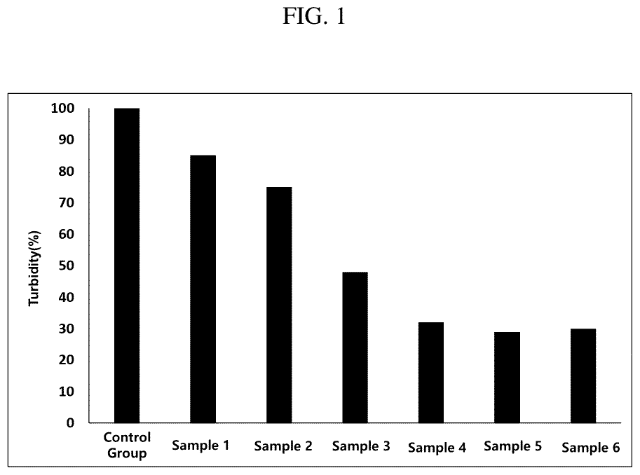

Composite resins (sample 1˜6) were prepared in the same manner as in Experimental Example 1, except that the content of the antibacterial agent was adjusted to 1 to 6 parts by weight relative to 100 parts by weight of the base composition, respectively. The antibacterial properties of each prepared composite resin were evaluated, and the results are shown in FIG. 1. Specifically, the cured sample was added to a liquid medium, the sample strain was inoculated and cultured for 24 hours, and then the turbidity of culture solution was measured to evaluate antibacterial properties. In addition, the turbidity in the medium (control group 1) without any composite resin sample was set at 100%, and the turbidity of each sample was calculated as a relative value to the control group and the results are shown in FIG. 1.

The more actively the strain reproduced, the higher the turbidity of the culture medium after culturing. The results of the experiment showed that in samples 1 to 3, turbidity was not significantly reduced compared to the control group, but in samples 4 to 6, turbidity was very low, around 30%, and the turbidity difference between them was not significant. Thus, it could be confirmed that samples 4 to 6 had the best antibacterial properties.

Therefore, it could be confirmed from the result of this experiment that when lysozyme was used as an antibacterial agent, it was preferable to include 4 to 6 parts by weight of the antibacterial agent based on 100 parts by weight of the base composition.

### Preparation Example 2

UDMA, BIS-GMA, BIS-EMA, and TEGDMA were placed in a vacuum mixer and stirred at 45° C. under 10 rpm and a vacuum gauge pressure of 0.07 MPa to prepare a second polymer mixture. Then, a photoinitiator (Camphorquinone), a photoinitiator aid (DIFP), an accelerator (EDMAB), an antioxidant (BHT), and an anti-discoloration agent (Tinuvin) were added thereto, and stirred at the same temperature, stirring speed, and vacuum to prepare a second base composition. Subsequently, the antibacterial material and filler (silica) were added to a vacuum mixer containing the second base composition, and stirred under the same conditions to prepare a uniform composition. Then, the obtained composition was aged for 50 hours at 33° C. to prepare an antibacterial and antiviral 3D printing denture base resin composition. The composition of the resin composition thus prepared is shown in Table 5.

The antibacterial material prepared by naturally thawing a third precursor obtained by the following step was used: stirring pectin, protamine, and collagen in a weight ratio of 3:4:3 for 6 hours at 60° C. at a stirring speed of 4 rpm, and then freeze-drying the mixture for 12 hours to prepare a first precursor; naturally thawing the first precursor at room temperature, stirring it for 12 hours at 70° C. at a stirring speed of 4 rpm, and then freeze-drying it for 24 hours to prepare a second precursor; and mixing the second precursor and phospholipids in a weight ratio of 1:1, stirring the mixture for 12 hours at 70° C. at a stirring speed of 3 rpm, and then freeze-drying the mixture for 24 hours to prepare a third precursor. The process in which stirring was performed during the entire process was performed under a vacuum with a vacuum gauge pressure of 0.07 MPa.

TABLE 5

| Raw material name | Content (wt %) |
|---|---|
| UDMA | 7.6 |
| BIS-GMA | 55.4 |
| BIS-EMA | 23.3 |
| TEGDMA | 4.2 |
| Photoinitiator | 1.3 |
| Photoinitiator aid | 0.1 |
| Filler | 4.0 |
| Accelerator | 0.6 |
| Antioxidant | 0.3 |
| Anti-discoloration agent | 0.2 |
| Antibacterial material | 3.0 |
| Total | 100.0 |

### Experimental Example 5

Resin compositions (sample 11˜15) with various compositions were prepared in the same manner as in Preparation Example 2, except that the content of the antibacterial material included in the total composition was changed to 1 to 5 wt %. Here, the total content of the remaining mixture excluding the antibacterial material was changed according to the increase or decrease in the content of the antibacterial material to offset the increase or decrease in the content of the antibacterial material. Afterwards, each resin composition was 3D printed to a size of 64 mm×10 mm×3.3 mm and then photocured to prepare five specimens each.

Each specimen was mounted on a universal material testing machine and bent at a speed of 5 mm/min until fracture, the load at fracture (F) was recorded, and the height (h) and breadth (b) of the specimen were measured. Then, the bending strength (OB) was calculated using the following Equation 1. In Equation 1, “l” refers to a distance between the supports of the universal material testing machine. Five specimens were prepared for each antibacterial agent content, an experiment was performed on each specimen, and the bending strength was calculated. Thereafter, the results and average values are shown in Table 6.

$${σ}_{B} = \frac{3 Fl}{2 {bh}^{2}} \qquad [ Equation 1 ]$$

TABLE 6

| | Antibacterial material content (wt %) | | | | |
|---|---|---|---|---|---|
| | 1 | 2 | 3 | 4 | 5 |
| Bending | 82 | 80 | 78 | 67 | 62 |
| strength | 83 | 79 | 79 | 70 | 63 |
| (MPa) | 84 | 84 | 75 | 71 | 65 |
| | 82 | 82 | 79 | 63 | 61 |
| | 81 | 81 | 75 | 64 | 63 |

The results of the experiment showed that when the content of antibacterial materials was 1 to 3 wt %, the bending strength in all specimens was 65 MPa or more, which is the standard required by the Ministry of Food and Drug Safety, but when the content of antibacterial materials was 4 wt %, only some specimens satisfied these criteria, and when the content of antibacterial materials was 5 wt %, most specimens did not satisfy the standard. Accordingly, it could be confirmed that the bending strength of the individual denture base was 65 MPa or more, and it was desirable to include 1 to 3 wt % of the antibacterial material in the total resin composition to achieve uniform quality.

### Experimental Example 6

The antibacterial materials were prepared in the same manner as in Preparation Example 2, except that a content ratio of pectin, protamine, and collagen was varied as shown in Table 7. The resin compositions were prepared using the same manner as in Preparation Example, with the content of the antibacterial material in the resin composition fixed at 3 wt %. After that, the same bending strength evaluation as in Experimental Example 5 was performed, and the results are shown in Table 8.

TABLE 7

| | Pectin | Protamine | Collagen | Weight ratio of |
|---|---|---|---|---|
| | (A) | (B) | (C) | A:B:C |
| Sample 11 | 10 | 60 | 30 | 1:6.0:3.0 |
| Sample 12 | 20 | 50 | 30 | 1:2.5:1.5 |
| Sample 13 | 30 | 40 | 30 | 1:1.3:1.0 |
| Sample 14 | 40 | 30 | 30 | 1:0.75:0.75 |
| Sample 15 | 50 | 20 | 30 | 1:0.4:0.6 |
| Sample 16 | 60 | 10 | 30 | 1:0.17:0.5 |

TABLE 8

| | Bending strength (MPa) | | | | |
|---|---|---|---|---|---|
| Sample 11 | 71 | 75 | 70 | 69 | 70 |
| Sample 12 | 70 | 72 | 74 | 76 | 75 |
| Sample 13 | 78 | 79 | 75 | 79 | 75 |
| Sample 14 | 68 | 72 | 73 | 69 | 71 |
| Sample 15 | 67 | 70 | 70 | 67 | 66 |
| Sample 16 | 65 | 63 | 62 | 67 | 61 |

The experimental results showed that samples 11 to 15 satisfied the standard value of 65 MPa or more when measuring bending strength five times, but some specimens of sample 16 had bending strength less than the standard value. Therefore, to secure stable bending strength for each individual, pectin, protamine, and collagen included in the antibacterial material may preferably be included in a weight ratio of 1:0.3 to 7.0:0.55 to 4.0, and more preferably in a weight ratio of 1:0.4 to 6.0:0.6 to 3.0.

### Experimental Example 7

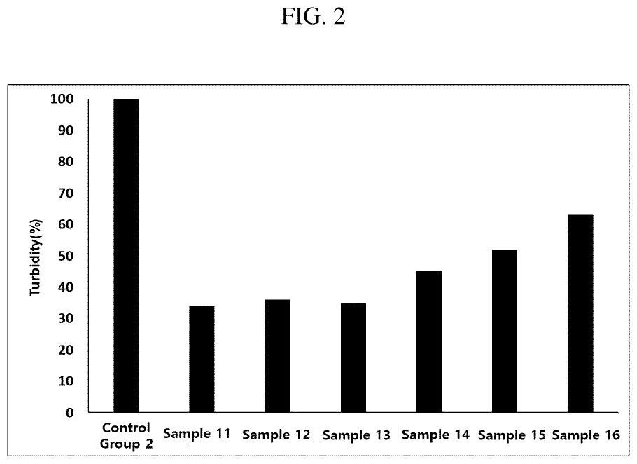

The antibacterial properties 41 each resin composition prepared in Experimental Example 6 were evaluated, and the results are shown in FIG. 2. Specifically, the cured sample was added to a liquid medium, the sample strain was inoculated and cultured for 24 hours, and then the turbidity of the culture solution was measured to evaluate antibacterial properties. In addition, the turbidity in the medium (control group 2) without any resin composition sample was set at 100%, and the turbidity of each sample was calculated as a relative value to the control group and the results are shown in FIG. 2.

The more actively the strain reproduced, the higher the turbidity of the culture medium after culturing. The results of the experiment showed that in samples 11 to 13, turbidity was maintained at a constant low turbidity of around 35%, but in samples 14 to 16, turbidity was increased than this. In particular, each sample had a fixed collagen content and changed the weight ratio of pectin and protamine. It was confirmed that as the pectin content increased and the protamine content decreased, turbidity increased, resulting in degradation of antibacterial properties.

Therefore, to secure high antibacterial properties, it could be confirmed that pectin, protamine, and collagen included in the antibacterial agent were preferably used in a weight ratio of 1:1 to 7:0.9 to 4, and preferably in a weight ratio of 1:1.3 to 6:1 to 3.

The composite resin for aesthetic restoration according to the present disclosure has excellent antibacterial properties, making it possible to secure resistance to bacteria and viruses. In addition, the composite resin for aesthetic restoration may be applied as a bulk-fill resin due to improved polymerization depth, and thus a stacked number during a procedure is reduced, preventing secondary dental caries due to a stacked interface, and shorting a procedure time.

Furthermore, the 3D printing denture base resin composition according to the present disclosure may be applied to 3D printing and achieve a bending strength of 65 MPa or more, which is the bending strength of resin used for denture bases. Also, the 3D printing denture base resin composition has antibacterial and antiviral performance, making it possible to secure resistance against bacterial or viral contamination of the denture base that is repeatedly removed from oral cavity.

### INDUSTRIAL AVAILABILITY

The composite resin for aesthetic restoration containing lysozyme, which has improved antibacterial properties and polymerization depth according to the present disclosure, contains 2 to 5 parts by weight of a filler, 4 to 6 parts by weight of an antibacterial agent, and 40 to 45 parts by weight of barium glass based on 100 parts by weight of the base composition, wherein the antibacterial agent is modified lysozyme. The composite: resin for aesthetic restoration has excellent antibacterial properties, may secure high resistance against bacteria or viruses, and may be applied as a bulk-fill resin due to improved polymerization depth, and thus a stacked number during a procedure is reduced, preventing secondary dental caries due to a stacked interface, and shorting a procedure time. Therefore, industrial availability exists.

What is claimed is:

1. A composite resin for aesthetic restoration with improved antibacterial properties and polymerization depth, comprising 2 to 5 parts by weight of a filler, 4 to 6 parts by weight of an antibacterial agent, and 40 to 45 parts by weight of barium glass, based on 100 parts by weight of the base composition containing urethane dimethacrylate (UDMA), bisphenol A-glycidyl methacrylate (BIS-GMA), bisphenol A dimethacrylate ethoxylated (BIS-EMA), triethylene glycol dimethacrylate (TEGDMA), a photoinitiator, a photoinitiator aid, an accelerator, an antioxidant, and an anti-discoloration agent,
wherein the antibacterial agent is modified lysozyme, and
wherein the modification of lysozyme is performed in a purification step of purifying a surface of lysozyme with ethanol; and a surface modification step of mixing surface-purified lysozyme and polyethylene glycol dimethacrylate (PEGDMA).

2. The composition resin for aesthetic restoration with improved antibacterial properties and polymerization depth of claim 1, wherein the base composition contains 5 to 20 wt % of UDMA, 40 to 70 wt % of BIS-GMA, 15 to 30 wt % of BIS-EMA, 3 to 6 wt % of TEGDMA, 0.5 to 2.5 wt % of photoinitiator, 0.02 to 0.2 wt % of a photoinitiator aid, 0.2 to 1 wt % of an accelerator, 0.05 to 0.5 wt % of an antioxidant, and 0.05 to 0.5 wt % of an anti-discoloration agent.

3. A method for preparing a composition resin for aesthetic restoration with improved antibacterial properties and polymerization depth, the method comprising:
a first step of preparing a polymer mixture by mixing UDMA, BIS-GMA, BIS-EMA, and TEGDMA;
a second step of preparing a base composition by mixing the polymer mixture with a photoinitiator, a photoinitiator aid, an accelerator, an antioxidant, and an anti-discoloration agent; and
a third step of preparing a composite resin by mixing the base composition with an antibacterial agent, a filler, and barium glass,
wherein the antibacterial agent is a modified lysozyme that had undergone a modification process and is included in the range of 4 to 6 parts by weight based on 100 parts by weight of the base composition, and
wherein the modification process includes: a purification step of purifying a surface of lysozyme with ethanol; and a surface modification step of mixing surface-purified lysozyme and PEGDMA.

4. The method of claim 3, wherein the composite resin prepared through the third step comprises 2 to 5 parts by weight of a filler, 4 to 6 parts by weight of an antibacterial agent, and 40 to 45 parts by weight of barium glass, based on 100 parts by weight of the base composition containing 5 to 20 wt % of UDMA, 40 to 70 wt % of BIS-GMA, 15 to 30 wt % of BIS-EMA, 3 to 6 wt % of TEGDMA, 0.5 to 2.5 wt % of a photoinitiator, 0.02 to 0.2 wt % of a photoinitiator aid, 0.2 to 1 wt % of an accelerator, 0.05 to 0.5 wt % of an antioxidant, and 0.05 to 0.5 wt % of an anti-discoloration agent.

5. An antibacterial and antiviral 3D printing denture base resin composition, comprising UDMA, BIS-GMA, BIS-EMA, TEGDMA, a photoinitiator, s photoinitiator aid, a filler, an accelerator, an antioxidant, an anti-discoloration agent, and an antibacterial material.

6. The antibacterial and antiviral 3D printing denture base resin composition of claim 5, wherein the antibacterial and antiviral 3D printing denture base resin composition comprises 5 to 20 wt % of UDMA, 40 to 70 wt % of BIS-GMA, 15 to 30 wt % of BIS-EMA, 3 to 5 wt % of TEGDMA, 0.5 to 2.5 wt % of a photoinitiator, 0.02 to 0.2 wt % of a photoinitiator aid, 2 to 6 wt % of a filler, 0.2 to 1 wt % of an accelerator, 0.05 to 0.5 wt % of an antioxidant, 0.05 to 0.5 wt % of an anti-discoloration agent, and 1 to 3 wt % of an antibacterial material.

7. The antibacterial and antiviral printing 3D denture base resin composition of claim 5, wherein the antibacterial material is pectin and/or protamine.
